(19) United States
(12) Patent Application Publication
(10) Pub. No.: US 2014/0278820 A1
(43) Pub. Date: Sep. 18, 2014

(54) Managing the Topology of Software Licenses in Heterogeneous and Virtualized Environments

(71) Applicant: iQuate Inc., San Francisco, CA (US)

(72) Inventors: Regnerus Dantuma, Dublin (IE); Jason J. Keogh, Dublin (IE); James Wilson, Dublin (IE); Rafe G. Slattery, Dublin (IE)

(73) Assignee: iQuate Inc., San Francisco, CA (US)

(21) Appl. No.: 14/208,538

(22) Filed: Mar. 13, 2014

Related U.S. Application Data
(60) Provisional application No. 61/778,430, filed on Mar. 13, 2013.

(51) Int. Cl. G06Q 10/06; H04L 12/26

(52) U.S. Cl. CPC G06Q 10/0637; H04L 43/0876
USPC 705/7.37; 709/224; 705/7.36

(57) ABSTRACT

Methods, computer-readable storage media, and systems provide both reactive and proactive data to customers about their licensing positions. This is done by (1) automatically scanning data centers for all servers without any agent technology required; (2) creating an inventory of all software on all servers; (3) making detailed measurements of the most complex and expensive software; e.g. databases by Oracle, Microsoft, IBM, and Sybase; (4) normalizing and storing the gathered data in a database; (5) providing simple graphical views of typical problem areas such as (5a) over-allocation or under-allocation of virtual machines, called macro-consolidation, and (5b) inefficient use of Oracle options, called micro-consolidation; and finally (6) providing a simple graphical interface for the customer to play out “what if” scenarios with virtualization and consolidation.

### CROSS-REFERENCE TO RELATED APPLICATION

This application claims the benefit of U.S. Provisional Application Ser. No. 61/778,430, filed on Mar. 13, 2013, which is hereby incorporated herein by reference.

### BACKGROUND

1. Technical Field

This invention pertains in general to managing software licenses, and in particular to managing software licenses in heterogeneous and virtualized computing environments.

2. Description of Related Art

Large software vendors, such as IBM, MICROSOFT, and ORACLE, have complex rules about software license compliance. For example, presently, in order to completely understand the compliance position for an ORACLE database, a customer must know the following about the database environment: (a) the hardware vendor, (b) the CPU chip manufacturer, (c) the CPU clock cycle, (d) the number of cores in the CPU, (e) the number of CPU's in the server, (f) configuration of virtualization on the server (e.g. VMWARE), (g) the configuration of clustering the server is involved in, (h) the type of database (e.g. Standard vs. Enterprise), (i) the ORACLE options installed on the database, (j) the ORACLE options in use by the customer, and not just in use by ORACLE processes, and potentially (k) the number of users accounts on the database. Considering that many customers have hundreds, or even thousands of ORACLE databases in a data center, the amount of data to be analyzed for a license compliance position can be daunting.

Audits of license compliance by large software vendors, such as ORACLE, can result in millions, or even tens of millions of dollars of penalties. These penalties are not usually the result of customer willfulness, but rather they result from customer ignorance due in part to the complexity of the compliance position. Moreover, if customers had easy access to their license compliance information, they could potentially go beyond mere compliance, and actually proactively manage some operations in their data centers to save money on license liability.

One method of managing servers in a data center is with tags. Data centers with a large number of virtual machines may have an application called a virtual machine manager, which is responsible for moving virtual machines around in the data center, generally for the purpose of managing performance. Virtual machine managers may have the ability to read tags. Tags are small files placed on the virtual machines to constrain and control the movement of the virtual machines. These tags may be configured to constrain the movement of virtual machines for the purpose of licensing optimization. For example, tags might be created on all virtual machines which are running ORACLE database with the “Spatial” option such that these machines are constrained to run on a specific hardware server. This greatly reduces the license liability for the “Spatial” option.

### SUMMARY

Embodiments of the invention provide methods, computer-readable storage media, and systems to provide both reactive and proactive data to customers about their licensing positions. This is done by (1) scanning data centers for all servers; since this is done automatically, and without any agent technology required, all server information is gathered, often including servers that the customer's IT department has lost track of; (2) creating an inventory of all software on all servers; (3) making detailed measurements of the most complex and expensive software, e.g. databases by ORACLE, MICROSOFT, IBM, and SYBASE; (4) normalizing and storing the gathered data in a database; (5) providing simple graphical views of typical problem areas such as (5a) over-allocation or under-allocation of virtual machines, called macro-consolidation, and (5b) inefficient use of ORACLE options, called micro-consolidation; and finally, optionally, (6) providing a simple graphical interface for the customer to play out “what if” scenarios with virtualization and consolidation.

Embodiments of the computer-readable storage medium store computer- executable instructions for performing the steps described above. Embodiments of the system further comprise a processor for executing the computer-executable instructions.

The features and advantages described in the specification are not all inclusive and, in particular, many additional features and advantages will be apparent to one of ordinary skill in the art in view of the drawings, specification, and claims. Moreover, it should be noted that the language used in the specification has been principally selected for readability and instructional purposes, and may not have been selected to delineate or circumscribe the inventive subject matter.

### BRIEF DESCRIPTION OF DRAWINGS

FIG. 1 is a high-level block diagram of a computing environment for managing the topology of software licenses in heterogeneous and virtualized environments, in accordance with an embodiment of the invention.

FIG. 2 is a block diagram of the analysis system of FIG. 1, in accordance with an embodiment of the invention.

FIG. 3 is a flow chart illustrating a method of reporting under-utilization of Information Technology (“IT”) resources, in accordance with an embodiment of the invention.

FIG. 4 is a screenshot of a report illustrating under-utilization of resources, in accordance with an embodiment of the invention.

FIG. 5 is a flow chart illustrating a method of reporting opportunities for savings based on specifications and price for technology components, in accordance with an embodiment of the invention.

FIG. 6 is a screenshot of a report illustrating opportunities for savings, in accordance with an embodiment of the invention.

FIG. 7 is a flow chart illustrating a method of reporting potential savings associated with a what-if scenario, in accordance with an embodiment of the invention.

FIG. 8 is a screenshot of a report and user interface for inputting a what-if scenario and displaying resulting cost savings, in accordance with an embodiment of the invention.

The figures depict embodiments of the present invention for purposes of illustration only. One skilled in the art will readily recognize from the following description that alternative embodiments of the structures and methods illustrated herein may be employed without departing from the principles of the invention described herein.

### DETAILED DESCRIPTION

Embodiments of the invention manage the topology of software licenses in heterogeneous and virtualized environments. Specifically, embodiments of the invention provide both reactive and proactive data and analysis to customers about their licensing positions with respect to their IT resources in their data center. Figure (FIG. 1 is a high-level block diagram of a computing environment for performing such analysis, in accordance with an embodiment of the invention. The computing environment includes a data center 110, an analysis system 120, at least one report 130, and possibly one or more tags 140.

The data center 110 comprises a plurality of computing devices that collectively store and access data for a business, organization, or other large entity. The data center is heterogeneous. A heterogeneous data center is one which has the potential of multiple different machine sizes, hardware vendors, operating systems, clustering environments, and virtualization environments. In some cases, the data center may comprise so many machines of various types, each having various software installations and options, that it would be difficult and time consuming, if not impossible, to accurately track all of the relevant data that would be needed to assess compliance with various license schemes and utilization levels of the deployed resources. The data center also tends to be virtualized, at least to some degree. A virtualized server is one which has been configured with multiple virtual machines—each in itself appearing to be as single machine. Depending on the implementation, the data center may be centralized or geographically dispersed.

The analysis system 120 is a system that gathers data relevant to the IT configuration of the data center in order to analyze the data to determine compliance with vendor licenses, determine opportunities for cost savings, and/or allow a customer to test various what-if scenarios to determine the cost for alternative arrangements. The analysis system 120 may be implemented in one or several parts, and will be described in greater detail below, with reference to FIG. 2.

The report 130 is generated by the analysis system 120. The report may illustrate opportunities for cost savings, alternative configurations and associated costs, or the like. Examples of different reports are illustrated in the figures as screenshots of a user interface, but the reports may be output from the analysis system 120 as electronic documents or paper documents of various kinds

Tags 140 are generated by the analysis system 120. A tag 140 is a small file which is placed on a machine or a virtual machine in the data center. Tags 140 may be used by 3^{rd} party applications called virtual machine managers, in order to constrain and control the actions available for the movement of that virtual machine, in this case for the optimization of licensing liability.

FIG. 2 is a block diagram of the analysis system 120 of FIG. 1, in accordance with an embodiment of the invention. The analysis system 120 includes a scanning engine 121, a normalization engine 122, an IT configuration data repository 123, specifications and pricing data repository 124, and a reporting engine 125.

The scanning engine 121 automatically scans the data center 120 of a customer to gather data about the IT configuration. The scanning is implemented automatically because a high degree of accuracy is required to fully comply with license requirements. In one implementation, the scanning engine 121 is provided with elevated levels of credentials to a customer's data center so that the data center computers can be discovered and queried for data gathering purposes. In one embodiment, the IT configuration data gathered includes information about the hardware (e.g., CPU manufacturer, CPU model, CPU clock cycle, number of cores, system manufacturer, and number of CPUs persisting in the system), system software (e.g., clustering configuration, virtualization configuration, and operating system), and infrastructure software (e.g., manufacturer, version, options installed, options in use, and users enabled).

The normalization engine 122 optionally normalizes the data gathered for a customer's data center. The normalization engine may normalize the data by consolidating data gathered by different scanning engines at different geographic sites or at different times, or during different versions of the scan. The normalization engine 122 may also optionally perform various error checking operations to ensure that the data retained for analysis purposes is high quality. Inconsistencies in the data may be flagged for review prior to further analysis.

The IT configuration data repository 123 stores the IT configuration data obtained by the scanning engine 121 and optionally normalized by the normalization engine 122. The IT configuration data repository 123, for example, may be organized as a relational database that contains one record per data center machine that stores all of the IT configuration data that was gathered for that machine during a specific scan.

The specifications and pricing data repository 124 stores specifications and pricing data for hardware (e.g., system configurations and pricing), system software (e.g., virtualization software configuration and pricing), and infrastructure software (e.g., licensing rules including pricing of license types such as enterprise or standard editions, options, and pricing based on number of users). Data may be loaded to the specifications and pricing data repository by an administrator or a customer, and may be updated periodically to reflect new pricing and product descriptions for various technology components. The specifications and pricing data repository 124 provides these data to the reporting engine 125 to enable pricing analysis of IT configurations based on their technology components.

The reporting engine 125 analyzes the IT configuration data from the repository 123 and the specifications and pricing data from the repository 124 to generate reports, such as report 130. The reporting engine 125 includes a reporting database 126, comparison logic 127, and a user interface module 128.

The reporting database 126 of the reporting engine 125 caches large amounts of the IT configuration data so that different reporting views of the IT configuration data can be quickly accessed and filtered. To create a report, the reporting engine 125 accesses a corresponding report format or template from the reporting database 126.

The comparison logic 127 compares the current IT configuration data to a target or desired utilization level, for example, to determine mismatches within the customer's data center. The comparison logic 127 may be configured to flag data where a resource is being under-utilized or over-utilized for subsequent reporting.

The user interface module 128 may be configured to display or output the report 130 to the customer. In some cases, the user interface module 128 may also be configured to accept input by the customer with respect to what-if scenarios for analysis, as will be described below with reference to FIGS. 7-8.

FIG. 3 is a flow chart illustrating a method of reporting under-utilization of IT resources, in accordance with an embodiment of the invention. In step 301, IT configuration data for the data center is received. For example, the IT configuration data may be received by the analysis system 120 as a result of a scan of a customer's data center 110 by the scanning engine 121. In one embodiment, the IT configuration data gathered includes information about the hardware (e.g., CPU manufacturer, CPU model, CPU clock cycle, number of cores, system manufacturer, and number of CPUs persisting in the system), system software (e.g., clustering configuration, virtualization configuration, and operating system), and infrastructure software (e.g., manufacturer, version, options installed, options in use, and users enabled), as described above.

In step 302, optionally, the IT configuration data is normalized. The normalization may be performed by the normalization engine 122 described above, and the normalized data may be stored in the IT configuration data repository 123.

In step 303, the IT configuration data is analyzed to determine under-utilization of IT resources (hardware, system software, infrastructure). The analysis may be performed by the reporting engine 125 with reference to report types stored in the reporting database 126. The comparison logic 127 of the reporting engine 125 may determine under- utilization of an IT resource by comparing the level of current utilization with a desired target utilization as defined by the specifications and pricing data repository 124. These values may be over-ridden by a customer. Alternatively, resources that are comparatively over-allocated may also be determined based on comparison to a default or customer-selected threshold.

In step 304, under-utilization is reported. For example, the reporting engine 125 may output a report 130 to a customer. The report may be displayed using the user interface module 128 or otherwise communicated to the customer. In one example, the report provides a list of the under-utilized resources. In another example, the report lists resources in order from the greatest opportunity for increasing utilization to the least opportunity for increasing utilization.

FIG. 4 is a screenshot of a report illustrating inefficient utilization of resources, in accordance with an embodiment of the invention. In this example, the report illustrates an efficiency category for each machine analyzed, based on the allocation percentage. The user has asked to show inefficiently allocated servers which are either under 0.7 (70%) allocated, or over 1.5 (150%) allocated. The inefficient servers that are flagged in this example can be flagged with a red dot (over-allocated) or a pink dot (under-allocated) or other symbol, whereas the servers within the specified range can be flagged with a green dot or other symbol to visually distinguish them from the inefficient servers. The colored dots may be displayed in the efficiency category column of the report illustrated in FIG. 4.

FIG. 5 is a flow chart illustrating a method of reporting opportunities for savings based on specifications and price for technology components, in accordance with an embodiment of the invention. The method of FIG. 5 begins similarly to the method of FIG. 3. In step 501, IT configuration data for the data center is received. In step 502, optionally, the IT configuration data is normalized.

In step 503, data on specifications and price for technology components is received, for example, from a specifications and pricing data repository 124 as illustrated in FIG. 2. The specifications and pricing data repository 124 may have been loaded, in advance, with data gathered for technology components and alternatives that are deemed to be potentially high value in terms of optimizing a data center. Items may be deemed potentially high value by a system administrator or a customer, in various implementations. The data on specifications and price for technology components can then be accessed by the reporting engine 125 for use in analyzing the IT configuration data.

In step 504, the IT configuration data cross correlated with specifications and price for technology components is analyzed to determine opportunities for savings. The analysis may be performed, for example, by the reporting engine 125 of the analysis system 120. The reporting engine 125 may find various kinds of inefficient licensing configurations, depending upon specification data received in step 503. Examples of inefficient licensing include (a) Sparse Vendor Configuration: for some vendors, the license obligations are such that if there is one instance of that vendor on a large virtual server, then all of the virtual machines on that server must be licensed, meaning that having a large virtual server, which could support many instances, but where only a few are deployed is extremely costly; and (b) Sparse Option Configuration: similarly, for some vendors, if an option is deployed on a server, then the entire virtual server must be licensed for that option, whereas coalescing like options on a single server will result in significant savings. The opportunities for savings may be determined to be, for example, greater consolidation of the data center, increasing virtualization on various data center machines, uninstalling various unused software, and similar recommended actions.

In step 505, the opportunities for savings are reported. For example, the reporting engine 125 may output a report 130 to a customer as described above with reference to FIG. 3.

In step 506, optionally tags 140 are generated. For example, the user may request the generation of tags 140 for the servers reported in a report 130. The analysis system 120 generates tags 140 as small files and sends them to the servers that have been marked as savings opportunities in step 505.

FIG. 6 is a screenshot of a report illustrating opportunities for savings, in accordance with an embodiment of the invention. As illustrated in FIG. 6, the allocation percentage column, which may be flagged in red, may represent the largest opportunity for savings. In this example report only those servers flagged in red are shown. The report shows sparse option configurations—servers where coalescing options onto single servers may result in savings. The annual cost and purchase price of various technology components may also be reported. In this example, while only the most egregiously inefficient servers are shown, the overall data center is reasonably optimized, as shown by a gauge or dial on the right side of the report which is pointing to a green section of the dial.

FIG. 7 is a flow chart illustrating a method of reporting potential savings associated with a what-if scenario, in accordance with an embodiment of the invention. Steps 701-705 correspond to steps 501-505 discussed above, and can be implemented similarly. Then, in step 706, user input regarding a what-if scenario is received. The input can be received, for example, from a customer interacting with a user interface displayed by the user interface module 128. The input for the what-if scenario allows a customer to see the potential financial impact of changes to their data center, such as by buying different hardware, increasing virtualization, and/or other changes. These changes are represented, for example, as sliders, drop down menu selections, or text entry boxes in a user interface.

In step 707, the IT configuration data is analyzed with specification and price for the technology components in the what-if scenario to determine new potential savings for implementing the data center according to the what-if scenario. For example, if a customer adjusts the average number of CPUs per server in their data center from 2 to 4, the cost of the resulting future environment can be computed, compared to the current cost, and the savings determined from the difference between them under this what-if scenario.

Accordingly, in step 708, the new potential savings can be reported to the customer. For example, the reporting engine 125 may output a report 130 to a customer as described above with reference to FIG. 3.

FIG. 8 is a screenshot of a report and user interface for inputting a what-if scenario and displaying resulting cost savings, in accordance with an embodiment of the invention. In this example, the scenario settings include an ORACLE discount amount, the number of CPUs per server, the number of cores per CPU, the ORACLE core factor, the CPU speed, the server RAM, the server cost, and the virtualization factor. Additional or alternative scenario settings may be used for other implementations of the report and user interface. In this example, the report displays current values for various parameters on the left side of the user interface, allows user input via the scenario settings sliders in the middle of the user interface, and displays the impact of the selected scenario on the right side of the user interface.

Thus, a customer can easily assess the fiscal impact of variations to the customer's existing data center. By harnessing the power of comprehensive data about the customer's data center technology components, the analysis and report aids the customer in making good decisions about resource expenditures, ultimately to enhance the cost efficiency of the customer's data center.

Additional Configuration Considerations

Some portions of the above description describe the embodiments in terms of algorithmic processes or operations. These algorithmic descriptions and representations are commonly used by those skilled in the data processing arts to convey the substance of their work effectively to others skilled in the art. These operations, while described functionally, computationally, or logically, are understood to be implemented by computer programs comprising instructions for execution by a processor or equivalent electrical circuits, microcode, or the like. Furthermore, it has also proven convenient at times, to refer to these arrangements of functional operations as modules, without loss of generality. The described operations and their associated modules may be embodied in software, firmware, hardware, or any combinations thereof.

The present invention also relates to an apparatus for performing the operations herein. This apparatus may be specially constructed for the required purposes, or it may comprise a general-purpose computer selectively activated or reconfigured by a computer program stored on a computer readable medium that can be accessed by the computer. Such a computer program may be stored in a computer readable storage medium, such as, but is not limited to, any type of disk including floppy disks, optical disks, CD-ROMs, magnetic-optical disks, read-only memories (ROMs), random access memories (RAMs), EPROMs, EEPROMs, magnetic or optical cards, application specific integrated circuits (ASICs), or any type of computer-readable storage medium suitable for storing electronic instructions, and each coupled to a computer system bus. Furthermore, the computers referred to in the specification may include a single processor or may be architectures employing multiple processor designs for increased computing capability.

As used herein any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

In addition, use of the “a” or “an” are employed to describe elements and components of the embodiments herein. This is done merely for convenience and to give a general sense of the disclosure. This description should be read to include one or at least one and the singular also includes the plural unless it is obvious that it is meant otherwise.

Upon reading this disclosure, those of skill in the art will appreciate still additional alternative structural and functional designs for performing the methods described herein. Thus, while particular embodiments and applications have been illustrated and described, it is to be understood that the present invention is not limited to the precise construction and components disclosed herein and that various modifications, changes and variations which will be apparent to those skilled in the art may be made in the arrangement, operation and details of the method and apparatus disclosed herein without departing from the spirit and scope as defined in the appended claims.

What is claimed is:

1. A computer-implemented method comprising:
receiving information technology configuration data for a heterogeneous and virtualized data center;
analyzing the information technology configuration data to determine under-utilization of information technology resources; and
reporting the under-utilization of information technology resources.

2. The method of claim 1, further comprising:
normalizing the received information technology configuration data by consolidating data across at least one selected from a group consisting of different scanning engines at different geographic sites, different scanning engines at different times, and different versions of the scan.

3. The method of claim 1, wherein information technology configuration data comprises information about hardware, system software, and infrastructure software.

4. The method of claim 1, wherein the under-utilization of information technology resources comprises at least one selected from a group consisting of Sparse Vendor Configuration of at least one server and Sparse Option Configuration of at least one server.

5. A computer-implemented method comprising:
receiving information technology configuration data for a heterogeneous and virtualized data center;
receiving data on specifications and price for technology components of the data center;
analyzing the information technology configuration data cross correlated with the specifications and price for technology components to determine opportunities for savings; and
reporting the opportunities for savings.

6. The method of claim 5, further comprising:
normalizing the received information technology configuration data by consolidating data across at least one selected from a group consisting of different scanning engines at different geographic sites, different scanning engines at different times, and different versions of the scan.

7. The method of claim 5, wherein the specifications and price for technology components comprises specifications and price for hardware, system software, and infrastructure software.

8. The method of claim 5, further comprising:
generating at least one tag for placement on a virtual machine of the data center, the tag constraining and controlling actions available for movement of the virtual machine to optimize license liability.

9. A computer-implemented method of claim 5, further comprising:
receiving user input regarding a what-if scenario;
analyzing the information technology configuration data with specifications and price for technology components in the what-if scenario to determine new potential savings; and
reporting the new potential savings.

10. The method of claim 9, further comprising:
normalizing the received information technology configuration data by consolidating data across at least one selected from a group consisting of different scanning engines at different geographic sites, different scanning engines at different times, and different versions of the scan.

11. A non-transitory computer readable storage medium executing computer program instructions, the computer program instructions comprising instructions for:
receiving information technology configuration data for a heterogeneous and virtualized data center;
analyzing the information technology configuration data to determine under-utilization of information technology resources; and
reporting the under-utilization of information technology resources.

12. The storage medium of claim 11, wherein the computer program instructions further comprise instructions for:
normalizing the received information technology configuration data by consolidating data across at least one selected from a group consisting of different scanning engines at different geographic sites, different scanning engines at different times, and different versions of the scan.

13. The storage medium of claim 11, wherein information technology configuration data comprises information about hardware, system software, and infrastructure software.

14. The storage medium of claim 11, wherein the under-utilization of information technology resources comprises at least one selected from a group consisting of Sparse Vendor Configuration of at least one server and Sparse Option Configuration of at least one server.

15. A non-transitory computer readable storage medium executing computer program instructions, the computer program instructions comprising instructions for:
receiving information technology configuration data for a heterogeneous and virtualized data center;
receiving data on specifications and price for technology components of the data center;
analyzing the information technology configuration data cross correlated with the specifications and price for technology components to determine opportunities for savings; and
reporting the opportunities for savings.

16. The storage medium of claim 15, wherein the computer program instructions further comprise instructions for:
normalizing the received information technology configuration data by consolidating data across at least one selected from a group consisting of different scanning engines at different geographic sites, different scanning engines at different times, and different versions of the scan.

17. The storage medium of claim 15, wherein the specifications and price for technology components comprises specifications and price for hardware, system software, and infrastructure software.

18. The storage medium of claim 15, wherein the computer program instructions further comprise instructions for:
generating at least one tag for placement on a virtual machine of the data center, the tag constraining and controlling actions available for movement of the virtual machine to optimize license liability.

19. The storage medium of claim 15, wherein the computer program instructions further comprise instructions for:
receiving user input regarding a what-if scenario;
analyzing the information technology configuration data with specifications and price for technology components in the what-if scenario to determine new potential savings; and
reporting the new potential savings.

20. The storage medium of claim 19, wherein the computer program instructions further comprise instructions for:
normalizing the received information technology configuration data by consolidating data across at least one selected from a group consisting of different scanning engines at different geographic sites, different scanning engines at different times, and different versions of the scan.
